(19) United States
(12) Patent Application Publication
(10) Pub. No.: US 2002/0030823 A1
(43) Pub. Date: Mar. 14, 2002

(54) Method and device for measuring thickness of test object

(75) Inventors: Ryo Kobayashi, Tokyo (JP); Noboru Takahashi, Tokyo (JP)

Correspondence Address: OLIFF & BERRIDGE, PLC, P.O. BOX 19928, ALEXANDRIA, VA, 22320, US

(73) Assignee: Nippon Maxis Co., Ltd., Tokyo (JP)

(21) Appl. No.: 09/905,937

(22) Filed: Jul. 17, 2001

(30) Foreign Application Priority Data
Jul. 26, 2000 (JP) 2000-225407
Apr. 23, 2001 (JP) 2001-124649

(51) Int. Cl. G01B 9/02

(52) U.S. Cl. 356/485

(57) ABSTRACT

The present invention is a thickness measurement device which allows high-speed, high precision and stable measurement with a simple configuration and with easy maintenance. A coherent light emitted from a light source 31 is transformed to a desired linearly polarized light by a polarizer 32, this linearly polarized light is entered into a test object 33 having double refraction, a normal beam and an abnormal beam are extracted, the extracted beams are entered into a wedge prism 34, and a beam which transmit through the measurement location of the test object 33 and has the phase difference which changes according to the total thickness of the test object 33 and the wedge prism 34 are extracted. The extracted light is received by an analyzer 35, components in one polarization direction are extracted for the normal beam and the abnormal beam, the interference between the normal beam component and the abnormal beam component in one polarization direction is generated, the generated interference is projected onto the screen of the image pickup unit 36 as an interference fringe, and the projected interference fringe is observed so as to measure the thickness of the test object 33 which depends on the dislocation of the interference fringe by the image processor 37.

### BACKGROUND OF THE INVENTION

1. Field of the Invention

The present invention relates to a method of measuring the thickness of a test object and device thereof, and more particularly to a method and device suitable for measuring the thickness of a transparent wafer having double refraction, such as quartz.

2. Description of the Related Art

An optical plate thickness measurement device for measuring the thickness of a substrate having double refraction has been proposed (e.g. Japanese Patent Laid-Open No. H9-292208). As FIG. 18 shows, this device comprises a laser light source 2 for generating a laser beam, a polarizer 3 for transforming the laser beam emitted from the laser light source 2 to a desired linearly polarized light and entering it to a test substrate 4, a detector 7 for extracting a component of one polarization direction from the laser beam transmitted through the test substrate 4, a photo-sensor 8 for detecting the light intensity of the laser beam extracted by the detector 7, a stepping motor 15 for rotary driving the detector 7 mounted on a disk 12 via a gear 13, and a rotary encoder 14 for detecting the rotation angle of the detector 7.

This device transforms a laser beam into a desired linearly polarized light using the polarizer 3 and enters this linearly polarized light to the test substrate 4, and at the same time, rotates the detector 7, which receives the laser beam transmitted through the test substrate 4 and extracts a component in one polarization direction, with the incident light axis at the center, so that two linearly polarized light components, which are perpendicular to each other, and two linearly polarized light components, which are shifted 45 from the above linearly polarized light components and are perpendicular to each other, are extracted, and the plate thickness of the test substrate 4 is measured based on the phase difference of these linearly polarized components.

The plate thickness t of the test substrate 4 is given by the following formula,

t=(λ/2π)·(1/dn)·Δ

where λ: the measurement wavelength, Δ: the phase difference of the test substrate, 2π; 360 degrees, dn; the refractive index difference between normal light and abnormal light. While sequentially rotating the detector 7 light intensity of I₁, I₂, I₃ and I₄ of each rotation angle (e.g. π/2, π/4, 0, −λ/4) is measured using the photo-sensor 8, Δ is determined from the respective measurement results, the phase difference Δ is substituted in the above formula, and the plate thickness t of the test substrate, such as quartz, is determined.

According to this device, when the plate thickness of a test substrate having double refraction is measured, the plate thickness can be accurately measured at a μm or less measurement accuracy without scratching the substrate surface, and even if the thickness of the test substrate is ½ or more of wavelength λ of the laser light source, the thickness of the test substrate can be measured.

The above described prior art, however, has various problems.

(1) It is necessary to measure the light intensity for each rotation angle for a plurality of times (4 times of measurement in this embodiment) while sequentially rotating the detector, and point data cannot be obtained all at once, so high-speed measurement is impossible. Particularly for TV5 (Thickness Variation Five Points) which is required for a crystal wafer, five points of point data must be measured, so high-speed measurement is difficult.

(2) A mechanical mechanism, such as a motor, gear and encoder, is involved, so maintenance is difficult, and a special control system, such as a peripheral circuit to control the mechanism, is necessary.

(3) An information volume to be obtained once is small, so if an error is included, it is difficult to remove the error, and high precision measurement cannot be expected.

(4) Thickness is measured by light intensity, so light attenuation due to a change of the light quantity and the thickness of a test object influences measurement, making measurement unstable.

(5) Thickness is detected not by an image pickup unit but by a photo-sensor, so if the finishing accuracy of each component of the device changes, correction is difficult, and the mechanical defects of each component of the device cannot be compensated.

(6) A part of the device (disk 12 and gear 13) is a contact type, so the test object tends to become scratched or contaminated, and operability is poor, since mounting to the device, including centering, is difficult.

It is an object of the present invention to provide a method of measuring the thickness of a test object and a device thereof where the above mentioned problems of prior art have been solved.

The theory of the present invention is as follows. As FIG. 4A and 4B show, when a polarizer 21 and an analyzer 22, which are comprised of polarizing plates, are overlayed on a same optical path, and the analyzer 22 is rotated (FIG. 4A), the transmitted light becomes lighter or darker every 90 (=π/2) (FIG. 4B). If the intensity of light is measured when the angle of the main axis of the two polarizing plates is φ, the relationship of the following formula (1) is established,

I(φ)=I₀ COS²φ (1)

Where I₀ is the transmission intensity of the polarizer (Malus's Theorem).

FIG. 5 shows the relationship between a cross-section of a crystal model having an inclined plane and a horizontal plane, and the phase of the waveform of the intensity of light which transmits through the crystal model. For the intensity of the light, light from the light source is linearly polarized by the polarizer, is irradiated to the crystal model 23 from the direction perpendicular to the horizontal plane, the light transmitted through the crystal model 23 is detected by the analyzer, and is measured by the CCD camera. The analyzer is set to the rotation position where the light intensity is the maximum. In the wedge prism shaped part 23a of the crystal model 23, which is polished to a predetermined angle, light intensity is periodically changed, and the phases thereof have equal intervals. In other words, the change of light intensity, which is obtained on the time axis by rotating the analyzer, is obtained as the spatial change of light intensity, without rotating the analyzer. This change of the light intensity is given by the formula (1). In the part 23b where the front and rear faces are in parallel and the thickness is constant, the change of light intensity is not observed, and brightness is flat.

FIG. 6 shows the relationship between a cross-section of a crystal model, where the plate thickness is differentiated by convex processing, and the phase of the waveform of the intensity of light which transmits through the crystal model. The light intensity periodically changes from the edge where the thickness of the crystal model 24 is thinnest, toward the center where the thickness is thickest, and the phase becomes gradually wider at unequal intervals.

The present invention is a method of measuring the thickness of a test object, comprising a step of projecting a pattern of a cyclic occulting light on a screen, a step of projecting a light pattern onto the screen through at least a measurement location of a test object which is transparent and has double refraction with respect to the light pattern, and a step of measuring the thickness of the measurement location correlated to the phase shift between the pattern projected through the measurement location and the pattern which is projected without transmitting through the measurement location, using the phase shift.

In the present invention, a wedge prism, for example, is used as a means of projecting the cyclic occulting light pattern on the screen. This is based on the knowledge that the phase of the waveform which passes through the wedge prism has equal intervals. The test plates are arranged on an optical path of the wedge prism, one composite wedge, where the thickness of the test plate is added to the wedge prism, is configured, and the thickness of the test plate is determined since the intensity of the light which transmits through this composite wedge prism is correlated to the thickness of the test plate.

In other words, when the image of light which transmits through the wedge prism is captured, the part where the light intensity is at the maximum is a bright band, and the part where the light intensity is at the maximum where phase is shifted 90 is a dark band, so an interference fringe is observed. The phase of the light intensity waveform shifts when a thickness of the test plate is added to the wedge prism. For example, let us look at the location where the light intensity of the wedge prism is at the maximum, and at the adjacent location where the light intensity is at the minimum. Thickness changes linearly at both locations. A test plate having a thickness corresponding to the change of the thickness between these two locations in overlayed to the wedge prism. Then the light intensity of the location where the light intensity is the maximum becomes the minimum, since the phase shifts 90, and the phase of the interference fringe, due to the light intensity waveform, changes according to the thickness of the test plate. Therefore the thickness of the test plate can be measured by this amount of change.

This first invention is a method of testing the thickness of a test object wherein a coherent light is transformed to a desired linearly polarized light by a polarizer, this linearly polarized light is entered into at least a measurement location of a test object having double refraction, a normal beam and an abnormal beam are extracted, and the extracted beams are again entered into the wedge prism having a double refraction, beams having a phase difference which changes according to the thickness of the test object and the wedge prism transmitting through the measurement location of the test object are extracted, extracted lights are received by an analyzer, a component in one polarization direction is extracted for the normal beam and the abnormal beam, interference between the normal beam component and the abnormal beam component in the polarization direction is generated, the generated interference is projected onto the screen as the interference fringe, and the thickness of the measurement location of the test object, which depends on the dislocation of the interference fringe, is measured by observing the projected interference fringe. To generate interference, the light of the light source must be coherent.

The second invention is a method of measuring the thickness of a test object wherein light is entered into the wedge prism and then entered into the test object, which is the opposite of the first invention. In other words, a coherent light is transformed to a linearly polarized light by a polarizer, this linearly polarized light is entered into the wedge prism having double refraction, a normal beam and an abnormal beam are extracted, the extracted beams are entered into at least a measurement location of the test object having double refraction, beams having a phase difference which changes according to the total thickness of the test object and the wedge prism on the optical path passing through the measurement location of the test object are extracted, the extracted light is received by the analyzer, a component in one polarization direction is extracted for the normal beam and the abnormal beam, an interference between the normal beam component and the abnormal beam component in the polarization direction is generated, the generated interference is projected onto the screen as the interference fringe, the projected interference fringe is observed, and the thickness of the measurement position of the measured object, which depends on the dislocation of the interference fringe, is measured. Instead of entering light into the test object and then entering into the wedge prism thereafter, the test object and the wedge prism may be switched so that light enters into the wedge prism first then into the test object.

The third invention is a measurement device of a test object having double refraction for measuring the thickness of the test object, comprising a light source, a polarizer for transforming light from the light source into a linearly polarized light and entering the light into at least a measurement location of the test object, a wedge prism which has double refraction and is disposed so as to generate a phase difference in the light which is transmitted on the optical path of the test object in a direction perpendicular to the optical path, an analyzer for generating an interference which depends on the thickness of the test object from the light transmitted through the measurement location of the test object and the wedge prism, and an image pickup unit for projecting the interference generated by the analyzer as an interference fringe. Since the thickness of the measurement location of the test object can be measured once with the simple structure of merely disposing a wedge prism on the optical path, high-speed measurement is possible compared with the case of measuring the thickness of the test object for a plurality of times.

The fourth invention is a thickness measurement device of a test object, where a wedge prism is disposed in front of the test object, which is opposite of the first invention where the wedge prism is disposed behind the test object. In other words, the present invention is a device for measuring the thickness of a test object having double refraction, comprising a light source, a polarizer for transforming light from the light source into a linearly polarized light, a wedge prism which has double refraction and is disposed so as to generate a phase difference in the light which is transmitted on the optical path of the polarizer in a direction perpendicular to the optical path and is entered to at least a measurement location of the test object, an analyzer for generating an interference which depends on the thickness of the test object from the light transmitted through the wedge prism and the test object, and an image pickup unit for projecting the interference generated by the analyzer as an interference fringe. The thickness of the test object can be measured at high-speed with the simple structure of merely disposing the wedge prism on the optical path, even if the measurement points are scattered at a plurality of locations.

In the above mentioned third and fourth inventions, it is preferable that a computing unit for determining the thickness of the measurement location of the test object by comparing the shift of the phase of the interference fringe due to the measurement location of the test object and the shift of the phase of the interference fringe due to a sample with a known thickness. The test object may be a single crystal wafer for a surface acoustic wave device and the measurement of the thickness may be a measurement to determine the difference between the maximum value and the minimum value at the specified five points in the wafer plane. The test object may be a blank for a mesa type crystal oscillator, where many holes are opened in the lattice on the surface by etching, and the measurement of the thickness may be a measurement of the thickness of the bottom of the holes, The test objects include a phase plate, and such an optical product as an optical low pass filter, in addition to a single crystal wafer for a surface acoustic wave device and a blank for a mesa type crystal oscillator.

### BRIEF DESCRIPTION OF THE DRAWINGS

FIG. 1 is a diagram depicting a general configuration of a thickness measurement device of a test object according to the embodiment;

FIG. 2A and 2B are diagrams of a captured image of an interference fringe by CCD according to the embodiment;

Pig. 3 is a diagram depicting a linear formula to determine the thickness according to the embodiment;

FIG. 4A and 4B are diagrams depicting the transmitted light through two polarizing plates and Malus's Theorem:

FIG. 5 is a diagram depicting the relationship between the cross-section of the linearly polished crystal model and the phase of the intensity waveform of the light which is transmitted through the crystal model;

FIG. 6 is a diagram depicting the relationship between the cross-section of the convex-processed crystal model and the phase of the intensity waveform of the light which is transmitted through the crystal model;

FIG. 7 is a diagram depicting a general configuration of the thickness measuring device of a test object according to a variant form of the embodiment;

FIG. 8 is a diagram depicting the dimensions of a wedge prism;

FIG. 9 is a diagram depicting an image of the Interference fringe captured by a CCD for a rectangular crystal blank according to the embodiment;

FIG. 10 is a diagram depicting an image of the interference fringe captured by a CCD for a rectangular crystal blank according to the embodiment;

FIG. 11 is a diagram depicting an image of the interference fringe captured by a CCD for a rectangular crystal blank according to the embodiment;

FIG. 12 is a diagram depicting an image of an interference fringe captured by a CCD for a rectangular crystal blank according to the embodiment;

FIG. 13 is a diagram of an image of an interference fringe capturing by a CCD for a bevel processed crystal blank according to the embodiment;

FIG. 14 is a plan view of a SAW wafer inspection device;

FIG. 15 is a side view of a SAW wafer inspection device:

FIG. 16 is a diagram depicting the positions of the orientation flat, index flat and measurement points of TV5.

FIG. 17 is a diagram depicting a general configuration of an appearance measurement device where a light source according to the embodiment is integrated; and

FIG. 18 is a diagram depicting a general configuration of an optical plate thickness measurement device of a prior art.

### DESCRIPTION OF THE PREFERRED EMBODIMENTS

Embodiments of the present invention will now be described.

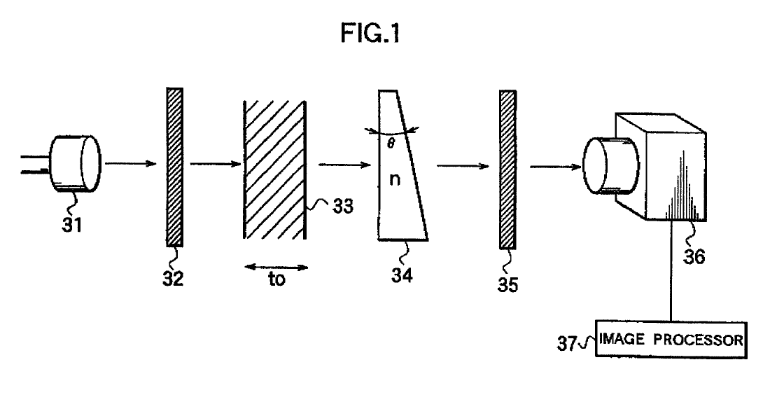

FIG. 1 shows a measurement device of a test object for measuring the thickness of a test object having double refraction. The test objects to be the targets of measurement of this measurement device are, for example, crystal blanks or wafers for a surface acoustic wave device. The wafer is comprised of a material which is transparent to the light emitted from the light source, such as the monocrystals of lithium niobate (LN), lithium tantalate (LT), lithium tetraborate (LOB), langasite, sapphire or diamond. The measurement device of the test object for measuring the test object is comprised of a light source 31, a polarizer 32, a wedge prism 34, an analyzer 35, a CCD camera 36, and an image processor 37. Instead of a wedge prism, such an optical component as a Wheller stone prism or Newton ring can be used.

For the light source 31, a light source which emits coherent light is used, and the wavelength preferably has a short wave length of 400-600 Angstrom in order to increase measurement accuracy. Here the light to be irradiated onto the surface of the test object is a beam which is narrowed to a several mm area in diameter. For such a light source, a light emitting diode (LED) or laser diode (LD) is preferable.

The polarizer 32 converts the light from the light source 31 to a linearly polarized light. The wedge prism 34, which is also called a thin prism, deflection angle prism, or beam deflection prism, has a wedge shape, and has wedge angle θ and refraction factor n. Generally a wedge prism is used for laser beams to prevent the reflection of a second wavelength plane, or for beam steering (selecting and detecting the path of a beam), but here the wedge prism is used to enter the beam extracted from the test object 33 disposed on the optical path between the polarizer 32 and the wedge prism 34, into the wedge prism 34 and to extract the beam through a phase according to the thickness on the optical path which transmits through the test object 33 and the wedge prism 34. Therefore the wedge prism 34 is disposed in the direction such that a plane not inclined or a plane inclined faces the direction perpendicular to the optical path. The optical axis direction must also be specified.

The wedge prism 34 is preferably comprised of a material which has the same double refraction as the test object 33, and a phase difference is generated in the light which transmits on the optical path of the polarizer in a direction perpendicular to the optical path. It is preferable to match the optical axes of the test object and the wedge prism 34. The optical axis direction of the wedge prism 34 is specified such that the intensity of light extracted from the wedge prism 34 becomes the maximum. The wedge angle θ is an angle 3-6 times the wavelength of the interference fringe (Moire fringes). This is to create 4-5 lines of interference fringes on the image capturing face, which is a screen for capturing images by the CCD camera 36. Since observation is based not on points but on a plane, the intensity of light need not be at the maximum.

The analyzer 35 interferes with the light which transmits through the test object 33, disposed on the optical path between the polarizer 32 and the wedge prism 34, and the wedge prism 34, and has the phase difference depending on the thickness of the test object 33. The analyzer 35 is set to a rotation position where the intensity of light to be detected is at the maximum.

The image pickup unit captures the image of the interfering light extracted from the analyzer 35 and observes it as interference fringe. On the image capturing face, the interference fringe, according to the total thickness of the test object 33 and the wedge prism 34 at the beam incident point on the test object 33, is projected. Since the total thickness of the test object 33 and the wedge prism 34 differs depending on the incident point position on the test object 33, the optical path length when the light transmits differs. Therefore the light emitted from the emission point of the wedge prism 34, corresponding to the incident point position, has a different phase depending on the optical path length. Along the inclined face of the wedge prism 34, the lights with phase differences λ/4, λ/2, 3λ/4, λ . . . are emitted from the emission face of the wedge prism 34. The lights with phase differences λ/4, 3λ/4 . . . are circularly polarized lights, and the lights with phase differences λ/2, λ . . . are linearly polarized lights. When the images of these lights are captured on the image capturing face of the image pickup unit 36, an interference fringe, where light/dark shading is generated at the 2π cycle, is generated. The image pickup unit 36 is, for example, a CCD camera.

The image processor 36 comprises a computing unit which compares the interference fringe projected onto the image pickup unit 36 and the reference interference fringe created by a test object with a known thickness, detects the phase difference Δ of the interference fringes, and determines the thickness of the test object 33 by the phase difference. The phase difference Δ is correlated with the thickness of the test object 33. Since the interference fringe position projected on the image capturing face shifts when the thickness of the test object 33 changes, the thickness of the test object 33 on the optical path, which transmits through a point of the test object 33 where an optical beam contacts, can be detected. The image processor 37 is configured by a personal computer, for example.

Now a measurement method of the thickness of a test object using the above mentioned device will be described.

A coherent light is emitted from the light source 31, such as an LED, and is transformed into a desired linearly polarized light by the polarizer 32. This linearly polarized light is entered into the test object 33 having double refraction, and a normal beam and an abnormal beam are extracted. The extracted beams are entered into the wedge prism 34, and a beam having a phase according to the thickness on the optical path which transmits through the test object 33 and the wedge prism 34 is extracted, the extracted beam is received by the analyzer 35, components in one polarization direction are extracted for the normal beam and the abnormal beam, interference between the normal beam component and the abnormal beam component in one polarization direction is generated, the generated interference fringe is projected onto the monitor of the image pickup unit, and the thickness of the test object, which depends on the interference fringe position, is measured by observing the projected interference fringe. The thickness of the test object can be measured because the thickness depends on the phase of the interference fringe, and the change of the phase of the interference fringe correlates to the thickness of the test object.

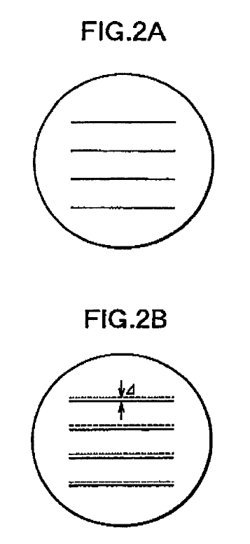

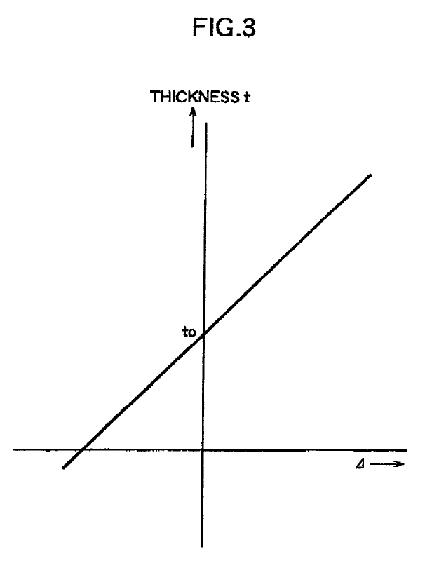

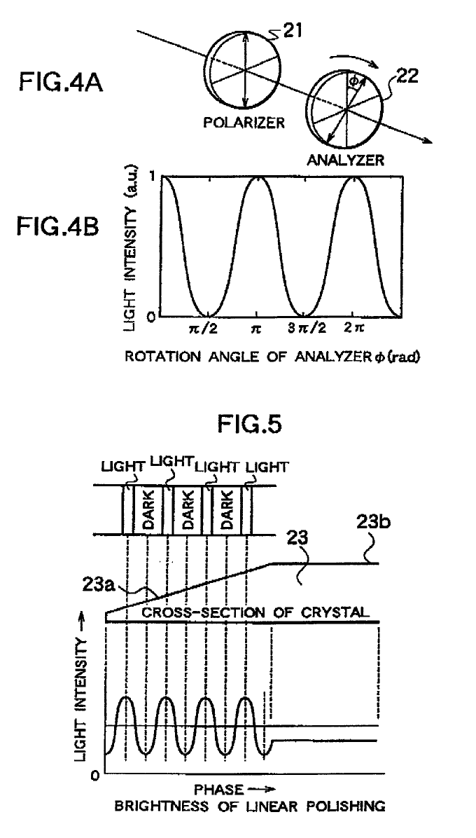

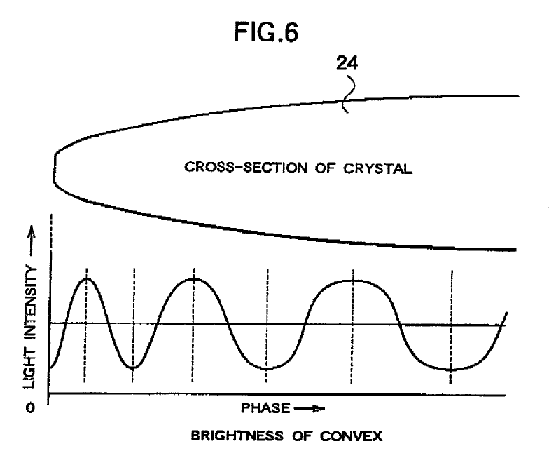

FIG. 2A and 2B show the status of an interference fringe at an arbitrary point of a test object projected onto a monitor. FIG. 2A shows only the reference interference fringe, and FIG. 2B shows the case when the reference interference fringe and the measurement interference fringe are overlayed. Considering the area of the beam spot, 4-5 lines of interface fringe are appropriate. If approximately this number of lines are actually used, the information volume to be obtained at once is large. So it is easy to remove an error when the information contains an error, and a high precision measurement can be expected.

The change Δ of the position of the interference fringe of the test object, with respect to the interference fringe of the reference sample, is the change of the thickness t of the test object, with respect to the thickness t₀ of the reference sample. If the thickness does not change, then Δ=0, where Δ increases as the change of thickness increases, and the sign of the value Δ inverts if the increase/decrease of the thickness change inverts. Here the conversion factor m of the thickness, with respect to Δ, is determined, and the linear formula shown in FIG. 3, that is,

t=t₀+m×Δ

is calculated by the image processor 37, then the result is the thickness of the test object.

As described above, according to the embodiment, the following effects are obtained compared with a prior art.

(1) It is unnecessary to measure a plurality of times for a spot of the test object, and the thickness data of a spot can be obtained instantaneously, so high-speed measurement is possible.

(2) Since there is no mechanical mechanism, maintenance is easy, and no special components (e.g. motor, gear, encoder), including peripheral circuits, are necessary.

(3) Since the information volume (4-5 lines) which can be obtained at once is large, high accuracy measurement is possible.

(4) Thickness (t) is measured by the phase of the wavelength (waveform), stable measurement is possible without the influence of the light attenuation due to the change of light quantity and thickness.

(5) The higher the finish accuracy of the wedge prism the higher the accuracy of the measurement, but some difference in the processing finish accuracy can be easily corrected and the mechanical defects can be compensated, since an image is captured by a CCD camera and that image is processed.

(6) The range of measurement can be increased by using two different types of wavelengths of a laser beam.

(7) In the case of a SAW wafer, the target measurement is 0.5 mm±50 μm and 0.35 mm ±50 μm. for example. If two different wavelengths are used for the light source, the thinner range (e.g. a 0.3 to 0.4 mm order) can be measured. The resolution is 1 μm (0.25 μm−0.5 μm/Dig).

(8) Material, other than quartz, can be used if that material has double refraction and becomes transparent to the light source wavelength.

(9) Since this involves a non-contact measurement, the test object is not scratched or contaminated. Mounting to equipment is easy and operability is good.

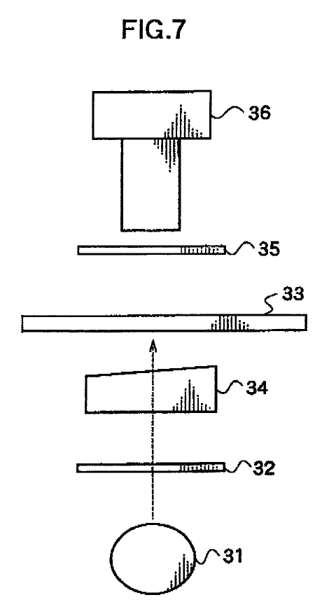

In the embodiment, a wafer for a surface acoustic wave device was used as an example of a test object, however a blank for a mesa type crystal oscillator, phase plate, optical low pass filter and other can be measured. The test object was disposed between the polarizer and the wedge prism, but may be disposed between the wedge prism and the analyzer. In other words, as FIG. 7 shows, the light source 31, the polarizer 32. the wedge prism 34, the test object 33, the analyzer 35 and the CCD camera 36 are disposed in this order. The merit of this arrangement is that the theory of the present invention can be intuitively understood. When a field of the interference fringe with equal intervals is created in advance by the wedge prism 34 and the test object 33 inserted into the field, the shift of the interference fringe, which is projected overlapping the test object image with respect to the interference fringe of the field for the amount corresponding to the thickness of the test object 33, can be realistically observed.

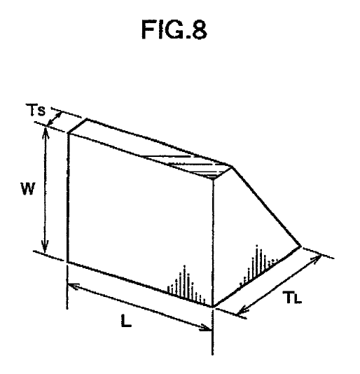

It is preferable that the wedge prism is comprised of material which has the same double refraction as the test object, but material which is different from the test object may be used if that material has double refraction. In this case, however, the wavelength and the double refraction values must be known in advance, and computing to determine the thickness is complicated. It is preferable that the wedge prism is one which makes the light intensity of the normal light and the abnormal light the maximum, The specific dimensions of the wedge prism shown in FIG. 8 is, for example, as follows. The width W 10 mm, the length L=10 mm, and the top side T_{S}=3 mm. If the base T_{L}=the top side T_{S}+(top side−base) δ, then δ can be changed to 0.5 mm, 1.0 mm or 1.5 mm depending on the number of interference fringes required. To downsize the wedge prism, a size around W×L=5 mm×5 mm is preferable.

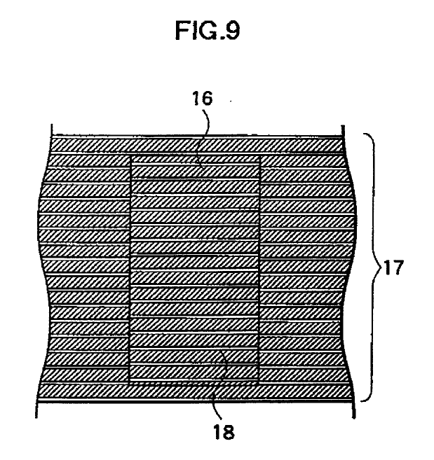

Now the thickness measurement of a crystal blank when the measurement points of a SAW wafer, where a five point measurement (TV5) is required, are regarded as small crystal blanks, will be described. FIG. 9 to FIG. 13 show examples of interference fringes when the thickness of crystal blanks are measured. The wedge prism used is width W=10 mm, length L=10 mm, top side T_{S}=3 mm and base T_{L}−1.0 mm. A red emitting light diode with a 660 nm wavelength was used as the transmitted light source. A blue light emitting diode with a 450 nm wavelength may be used instead.

FIG. 9 shows a qualitative captured image when the crystal blank 25, which is rectangular and has uniform thickness, is the test object, and is disposed in the interference fringe field 17 generated by the wedge prism. The light/dark shading of the interface fringe is given by the formula (1).

In FIG. 9, a spot measurement is not intended, so light irradiated to the crystal blank 25 is not focused by is irradiated onto the entire surface of the crystal blank 25. If the light is focused, the spot diameter should preferably be φ1-2 mm. The interference fringe 18 in the plane of the crystal blank 25 is shifted with respect to the interference fringe of the field 17. This shift corresponds to the thickness of the crystal blank.

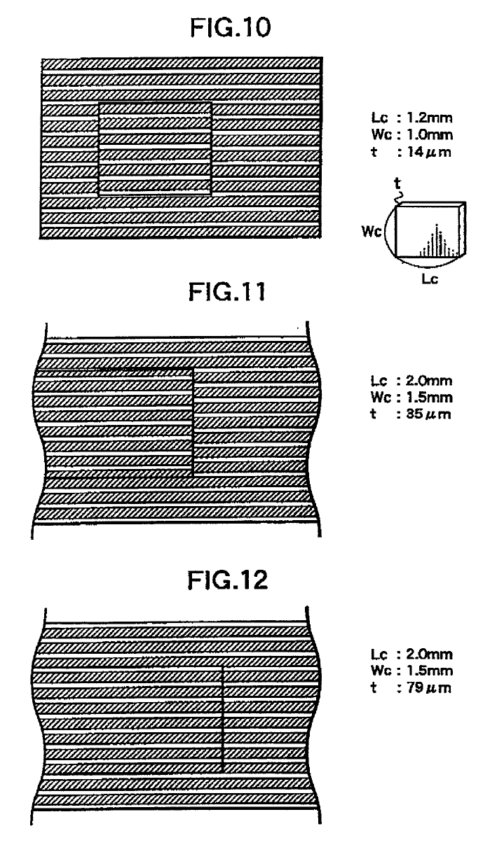

The dimensions of the rectangular crystal blank shown in FIG. 10 are length Lc=1.2 mm, width Wc=1.0 mm and thickness t=14 μm. As the thickness becomes thinner, the smaller the shift of the phase of the interference fringe on the crystal blank with respect to the field of the interference fringe. The dimensions of the rectangular crystal blank shown in FIG. 11 are length Lc=2.2 mm, width Wc=1.5 mm, and thickness t=35 μm. As the thickness becomes thicker than the one in FIG. 11, the shift of the phase is larger. The shift of the phase is about 90. The dimensions of the rectangular crystal blank shown in FIG. 12 are length Lc=2.0 mm, width Wc=1.5 mm, and thickness t=79 μm. Compared with the one in FIG. 11, thickness is a little more than double, so phase shifts about 180.

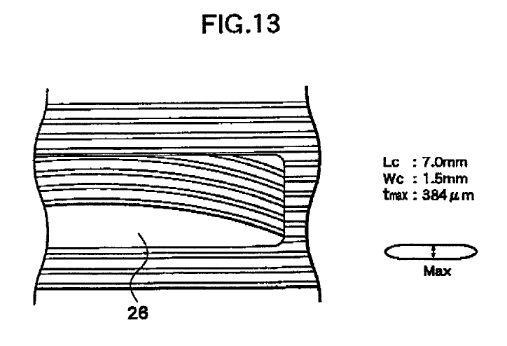

FIG. 13 shows the captured image when a crystal blank 26, which end face is bevel-processed, is disposed in a field 17 of interface fringe generated by a wedge prism. The dimensions of the crystal blank are length Lc=7.0 mm, Wc=1.5 mm and tₘₐₓ=384 μm. Since the plate thickness changes at the edge of the crystal blank, the interference fringe in the blank plane distorts according to the change, but is parallel to the interference fringe of the field, approaching closer to the center where the plate thickness does not change.

A method for improving the accuracy of thickness measurement is, for example, (1) decreasing wavelength λ of the light source, (2) increasing the magnification of the microscope, and (3) improving sub-pixel processing in image processing. For (1), the wavelength area is set from blue to purple. If a 300 nm ultraviolet light is used, high precision thickness measurement is possible. In the case of a red light source with a 660 nm wavelength, the order of thickness measurement is 110 μm, and in the case of a blue light source with a 450 nm wavelength, the order of thickness measurement is 75 μm. In an experimental example, the thickness is 9.375 μm if the measured phase shifted 45 from the reference phase, the thickness is 14 μm if the measured phase shifted 67, and the thickness is 18.75 μm if the measured phase shifted 90, and the thickness is 37.5 μm if the measured phase shifted 180.

[Embodiment]

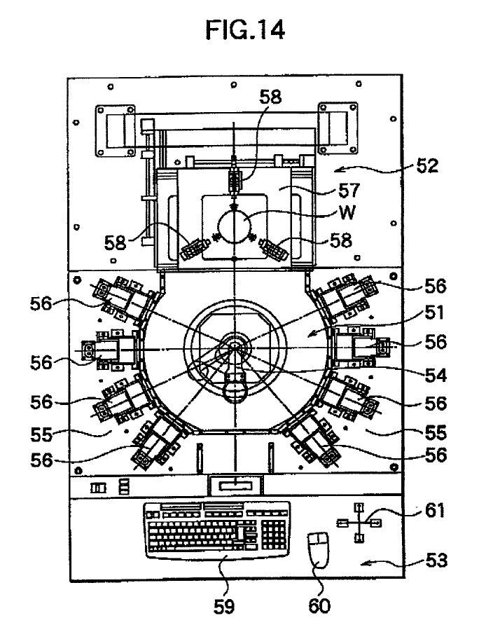

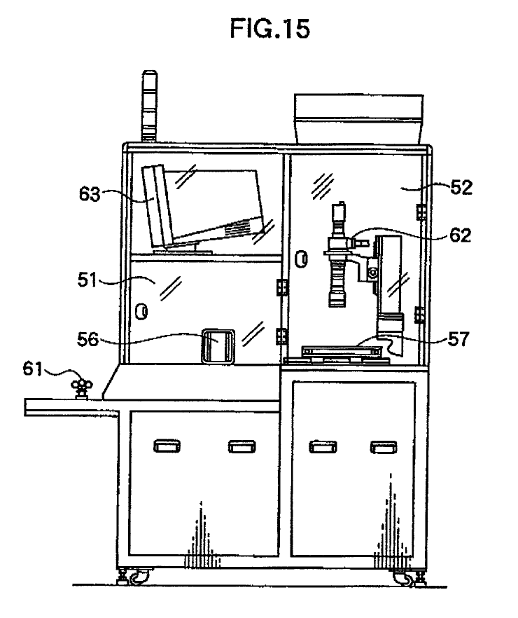

An embodiment when the above mentioned method of measurement of a test object and the device thereof are applied to a mono-crystal wafer for a surface acoustic wave device will now be described. FIG. 14 and FIG. 15 show a plan view and a side view of a SAW wafer inspection device.

FIG. 14 shows a transport chamber 51 for transporting a wafer to the center, an inspection chamber 52 behind the transport chamber 51 for inspecting the wafer W, and an operation table 53 in front of the transport chamber 51 for operating and controlling the device in the SAW wafer inspection device.

The transport chamber 51 comprises a wafer transport robot 54 at the center, and cassettes 55. which are at the left and right of the wafer transport robot 54. The wafer transport robot 54 samples a test wafer W before inspection from the wafer cassette 56, and transports it to the inspection chamber 52, and also transports a test wafer W after inspection in the inspection chamber 52 from the inspection chamber 52 to the transport chamber 51, and stores the wafer W in the wafer cassette 56. The cassette table 55 has a plurality of wafer cassettes 56 (4 cassettes each in this case) at the left and right side of the circumference, with the wafer transport robot 54 at the center. In each wafer cassette 56, a plurality of test SAW wafers are stored. For example, a test wafer W before inspection is stored in the wafer cassette 56 at the left, and a test wafer W after inspection is stored in the wafer cassette 56 at the right, according to the classification.

In the inspection chamber 52, a five point thickness, unevenness, appearance and shape of wafers are inspected. The inspection chamber 52 has an XY stage 57, a three support means 58 for supporting the outer circumference of the test wafer W at three points installed in the XY stage 57 in the circumference direction, so that the test wafer W, supported at three points, can be moved in the X and Y directions. By this movement, a five point measurement according to TV5 is also possible.

The operation table 53 is comprised of a keyboard 59, a mouse 60, and a joystick (operation lever) 61, which are connected to a computer, which is used as an image processor (not illustrated), and by this operation, the wafer transport robot 54 and the XY stage 57 are controlled so as to execute predetermined transport and inspection.

As FIG. 15 shows, a CCD camera 62 is installed above the XY stage 57 of the inspection chamber 52, and the CCD camera 62 captures the image of light which transmits from the light source for thickness measurement (not illustrated), through the polarizer, test wafer, wedge prism and analyzer, and displays the image on the display device 63 comprised of a monitor installed above the transport chamber 51.

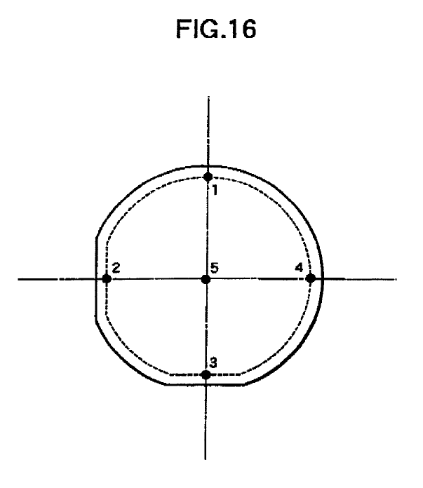

For an SAW wafer, it is required that TV5 be within a predetermined standard. As FIG. 16 shows, in order to inspect the five point thickness unevenness in the wafer plane, the interference fringe for a predetermined five points in the wafer plane of a reference wafer with a known thickness is observed, and the positions where the reference interference fringe is generated are stored in advance. The points where the reference interference fringe is sampled need not be five points, but may be an arbitrary point in the wafer plane.

The measured interference fringe position and the reference interference fringe position are compared, and the difference Δ is determined. The thickness of each point is determined using the above mentioned formula, the difference between the maximum value and the minimum value of these thicknesses is determined, and this value is regarded as the TV5 measurement.

According to this embodiment, the thickness of an arbitray point on the waver need not be measured for a plurality of times, but can be instantaneously measured once, so high-speed measurement is possible even when the number of measured points is five. For thickness measurement, an inspection mechanism for a dimensional inspection and an appearance inspection device, comprised of an XY stage and supporting means, can be used as is, so a peripheral circuit, motor, gear and encoder especially for thickness measurement are unnecessary. Also, for each measurement point. 4-5 lines of interference fringes are observed, and the phase difference A of each interference fringe is obtained, so the information volume which can be obtained once is high, and measurement at high accuracy is possible.

Since thickness is measured by the phase difference of the interference fringes, stable measurement is possible without the influence of the attenuation of light due to the change of light quantity and the thickness of the wafer. Also measurement is non-contact, so the test object can be measured without being scratched or contaminated. A non-contact measurement, just like dimensional measurement and appearance inspection, makes a 100% measurement possible, and is not a sampling inspection.

As for measurement accuracy, the surface roughness of a polished wafer is 0.06 μm (see page 26 of “Crystal Frequency Control Devices” by Shotaro Okano, published by Techno.) Since this is only one side, the surface roughness is 0.12 μm if both sides are considered. This value can be ignored considering that the measured value of the wafer thickness is 0.5 mm±50 μm and 0.35 nm±50 μm, and does not influence measurement accuracy. Therefore it is preferable to use a polished wedge prism.

In the embodiment, the case when the test object is a wafer for a SAW device where the surface is flat (surface is used) was described, but the present invention is also effective for the thickness measurement of a blank for a mesa type crystal oscillator (bulk is used), where many holes are opened in the lattice on the wafer by etching, and for such an optical product as an optical low pass filter. In this embodiment, an example of applying this method to TV5 was described, but the present invention can be applied to TTV and LTV.

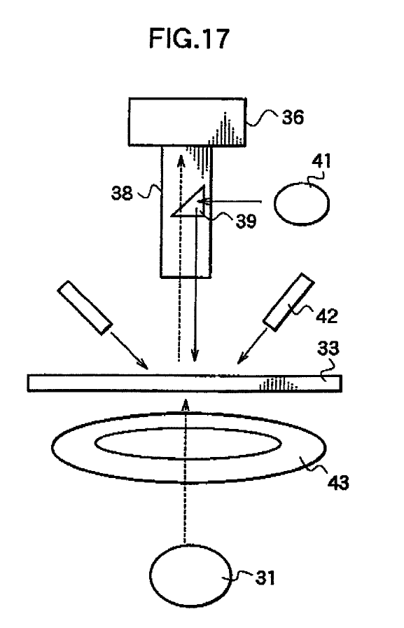

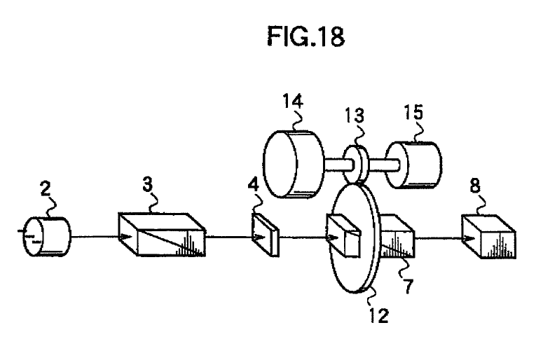

In the above embodiment, a five point thickness unevenness, appearance and shape of a wafer are inspected in the Inspection chamber 52, but as FIG. 17 shows, the light source of the measurement device can be integrated so as to optically execute an appearance inspection for appearance and shape without contact. In addition to the transmitted light source 31 for measuring the above mentioned thickness. a coaxial light source 41, an oblique light source 42, and a dark field light source 43 are disposed. The coaxial light source 41, where the axis of the microscope 38 and the illumination axis are aligned to be coaxial using a prism 39, illuminates a test object 33 through an objective lens, and reflected light is observed. The oblique light source 42 has a light source axis outside the microscope axis 38 with respect to a test object 33 on the axis, and illuminates the test object 33. The dark field light source 43 is a light source for observing only scattered light or diffracted light without allowing ring shaped illumination light to enter the field. (See e.g. Japanese Patent Laid-Open No. 2000-171401, Patent No. 3009659). The appearance and shape are inspected by switching these light sources, including the transmitted light source 31. Scratches and particles on the surface are detected by coaxial illumination. Scratches are detected by an oblique light. And cracks and beveling are detected by the dark field light (see e.g. Japanese Patent Laid-Open No. 19-288063, Patent No. 2821460). And as mentioned above, TV5 measurement is executed by transmitted light (double refraction).

According to the present invention, thickness can be instantaneously measured by a simple configuration where merely a wedge prism is disposed on the optical path. Even if a plurality of measurement points are scattered, high-speed measurement is possible. Since the wedge prism disposed on the optical path is secured, structure is more simplified compared with a device which measures thickness by rotating an analyzer for each measurement.

What is claimed is:

1. A method of measuring the thickness of a test object, comprising the steps of:
projecting a pattern of cyclic occulting light onto a screen;
projecting said light pattern onto said screen through at least a measurement location of a test object, which is transparent to said light pattern and has double refraction; and
measuring the thickness of said measurement location correlated to a phase shift between the pattern projected through said measurement location and said pattern which is projected without transmitting through said measurement location, using said phase shift.

2. The method of measuring the thickness of a test object according to claim 1, wherein the step of projecting said pattern of cyclic occulting light onto a screen further comprises the steps of:
transforming a coherent light to linearly polarizing light by a polarizer;
transmitting this linearly polarized light through an optical component having double refraction and extracting as normal light and abnormal light having a phase difference which changes according to the thickness of said optical component; and
transmitting said extracted normal light and said abnormal light into an analyzer to extract a component in one polarization direction and projecting the interference fringe due to interference of the normal light component and the abnormal light component in said one polarization direction onto the screen.

3. The method of measuring the thickness of a test object according to claim 2, wherein said optical component is a wedge prism.

4. The method of measuring the thickness of a test object according to claim 1, wherein said step of projecting said light pattern onto said screen through a test object which is transparent to said optical pattern and has double refraction further comprises the steps of:
inserting a test object which is transparent to said light and has double refraction into the optical path of said occulting light, and letting said light pattern transmit through at least the measurement location of said test object; and
projecting said pattern where a phase shift according to the thickness of said measurement location is generated with respect to said pattern projected onto said screen when the light is not transmitted through said test object onto said screen along with said measurement location.

5. A method of measuring the thickness of a test object comprising the steps of:
disposing a polarizer, wedge prism and analyzer sequentially on a same optical path and projecting the interference fringe due to said wedge prism where coherent light is entered from the polarizer and is emitted from the analyzer on a screen;
inserting the test object which is transparent to said light and has double refraction between said polarizer and said wedge prism, or between said wedge prism and said analyzer and projecting the image of at least the measurement location of said test object where the interference fringe due to said wedge prism and said test object is formed on said screen; and
measuring the thickness of the measurement location of said test object correlated to the phase shift between the interference fringe which is transmitted through said wedge prism and is projected onto said screen, and the interference fringe of the measurement location of said test object which is transmitted through said wedge prism and the measurement location of said test object and is projected onto said screen, using said phase shift.

6. The method of measuring the thickness of a test object according to claim 5, wherein the thickness of the measurement location of said test object is measured by comparing the phase shift of said interference fringe due to the measurement location of said test object and the phase shift of said interference fringe due to a sample with a known thickness.

7. The method of measuring the thickness of a test object according to claim 5, wherein said test object is a blank for a mesa type crystal oscillator where many holes are opened in the lattice on the surface by etching and said measurement of the thickness is the measurement of the thickness of the bottom of said holes.

8. The method of measuring the thickness of a test object according to claim 5, wherein said test object is a monocrystal wafer for a surface acoustic wave device.

9. The method of measuring the thickness of a test object according to claim S. wherein said measurement of thickness determines the difference between the maximum value and the minimum value of the thickness at specified five points in the wafer plane.

10. The method of measuring the thickness of a test object according to claim 5, wherein said mono-crystal wafer for a surface acoustic wave device is comprised of quartz, langasite, lithium tantalate (LT), lithium tetraborate (LBO), sapphire or diamond.

11. The method of measuring the thickness of a test object according to claim 5, wherein a plurality of lines of interference fringes are projected onto said screen, and the thickness of the measurement location of said test object is measured by equalizing the phase shift of the plurality of lines of interference fringes.

12. A thickness measurement device of a test object, comprising:
a screen:
pattern generation means for projecting a pattern of cyclic occulting light onto said screen; and
measurement means for measuring the thickness of said test object correlated to the phase shift between a pattern which does not transmit through said test object and a pattern which transmitted said test object projected on said screen when the test object which is transparent to said light and has double refraction is inserted into the optical path of said pattern, using said phase difference.

13. The thickness measurement device of a test object according to claim 12, wherein said pattern generation means further comprises:
said light source;
a polarizer which transforms the light from said light source into linearly polarized light and enters the light into said test object;
an optical component which has double refraction and is disposed so as to generate a phase difference in the light which transmits on the optical path of said test object in a direction perpendicular to said optical path; and
an analyzer for generating an interference which depends on the thickness of said test object from the lights which transmit through said test object and said wedge prism,

14. The thickness measurement device of a test object according to claim 12, wherein said pattern generation means further comprises:
a light source;
a polarizer for transforming light from said light source to linearly polarized light;
an optical component which has double refraction and is disposed so as to generate a phase difference in the light which transmits on the optical path of said polarizer in a direction perpendicular to said optical path and to enter the light into said test object; and
an analyzer for generating interference which depends on the thickness of said test object from the light which has transmitted through said optical component and said test object.

15. The thickness measurement device of a test object according to claim 13 or claim 14 wherein said optical component is a wedge prism.

16. The thickness measurement device of a test object according to claim 13 or claim 14 wherein said optical component is a Wheller stone prism.

17. The thickness measurement device of a test object according to claim 13 or claim 14 wherein said optical component is a Newton ring.

18. The thickness measurement device of a test object according to claim 12 further comprising a computing unit which determines the thickness of the measurement location of said test object by comparing the phase shift of said interference fringe due to the measurement location of said test object and the phase shift of said interference fringe due to a sample with a known thickness.

19. The thickness measurement device of a test object according to claim 12, wherein said light source is a light emitting diode.

20. The thickness measurement device according to claim 19, wherein said light emitting diode is a blue light emitting diode.
